(19) United States
(12) Patent Application Publication
(10) Pub. No.: US 2026/0135015 A1
(43) Pub. Date: May 14, 2026

(54) FLAT FLEXIBLE CABLE HARNESS ASSEMBLY

(71) Applicant: TE Connectivity Solutions GmbH, Schaffhausen (CH)

(72) Inventors: Christopher Ryan Raybold, Middletown, PA (US); Adam Price Tyler, Middletown, PA (US); David Bruce Sarraf, Middletown, PA (US)

(21) Appl. No.: 19/023,727

(22) Filed: Jan. 16, 2025

Related U.S. Application Data
(60) Provisional application No. 63/718,828, filed on Nov. 11, 2024.

(51) Int. Cl. H01B 7/00; H01B 7/08

(52) U.S. Cl. CPC H01B 7/0045; H01B 7/08

(57) ABSTRACT

A FFC harness assembly includes a main FFC having a main FFC cable and a main connector terminated to an end of the main FFC cable. The main FFC cable includes main flat wires and a main cable body. The FFC harness assembly includes a branch FFC separate and discrete from the main FFC. The branch FFC includes a branch FFC cable and a branch connector terminated to an end of the branch FFC cable. The branch FFC cable includes branch flat wires and a branch cable body. The FFC harness assembly includes an interconnect at a branch location between the main FFC and the branch FFC. The interconnect is located between the main FFC and the branch FFC and electrically connects at least one of the main flat wires with at least one of the branch flat wires to electrically connect the branch connector to the main connector.

### CROSS REFERENCE TO RELATED APPLICATIONS

This application claims benefit to U.S. Application No. 63/718,828, filed 11-Nov.-2024, the subject matter of which is herein incorporated by reference in its entirety.

### BACKGROUND OF THE INVENTION

The subject matter herein relates generally to harness assemblies.

Harness assemblies are used to connect electrical and electronic components within a system. For example, harness assemblies may be used in automotive applications to connect a vehicle control or management system to electronic controls, lighting, air conditioning, and other components of the vehicle. Harness assemblies transmit electrical power and signals between components, such as the control module, the battery, lighting devices, sensors, and the like. Harness assemblies may be used in other applications, such as aerospace, defense, appliances, automation, industrial machines, and the like.

Harness assemblies typically include multiple wires arranged in a wire bundle or harness, which are terminated at one end to an electrical connector and at the other end to a different electrical connector. Typically, the wires of such wire harness assemblies are branched from the main wire bundle to extend to different, secondary connectors. For example, a single main connector may be connected to two, three or more secondary electrical connectors by different groups of the wires.

Wire harness manufacturers are under pressure to keep costs low to meet the demands of OEMs, who want to reduce their own manufacturing costs. Wire harnesses are complex assemblies of many components that can be configured in many ways. Wire layouts of the wire harnesses can be complex.

There is a need for cost effective and reliable harness assemblies, such as for use in vehicle wiring.

### BRIEF DESCRIPTION OF THE INVENTION

In one embodiment, a flat flexible cable (FFC) harness assembly is provided and includes a main FFC which includes a main FFC cable and a main connector terminated to an end of the main FFC cable. The main FFC cable includes main flat wires and a main cable body has an insulator supporting the main flat wires. The main flat wires include terminals at the end of the main FFC terminated to the main connector. The FFC harness assembly includes a branch FFC separate and discrete from the main FFC. The branch FFC includes a branch FFC cable and a branch connector terminated to an end of the branch FFC cable. The branch FFC cable includes branch flat wires and a branch cable body having an insulator supporting the branch flat wires. The branch flat wires include terminals at the end of the branch FFC terminated to the branch connector. The FFC harness assembly includes an interconnect at a branch location between the main FFC and the branch FFC. The interconnect is located between the main FFC and the branch FFC. The interconnect electrically connects at least one of the main flat wires with at least one of the branch flat wires to electrically connect the branch connector to the main connector.

In another embodiment, a flat flexible cable (FFC) harness assembly is provided and includes a main FFC which includes a main FFC cable and a main connector terminated to an end of the main FFC cable. The main FFC cable includes main flat wires and a main cable body having an insulator supporting the main flat wires. The main flat wires include terminals at the end of the main FFC terminated to the main connector. The FFC harness assembly includes a branch FFC separate and discrete from the main FFC. The branch FFC includes a branch FFC cable and a branch connector terminated to an end of the branch FFC cable. The branch FFC cable includes branch flat wires and a branch cable body having an insulator supporting the branch flat wires. The branch flat wires include terminals at the end of the branch FFC terminated to the branch connector. The FFC harness assembly includes an interconnect between the main FFC and the branch FFC. The interconnect includes an interconnect housing and interconnect conductors held by the interconnect housing. Each interconnect conductor includes a first interface electrically connected to the corresponding main flat wire and a second interface electrically connected to the corresponding branch flat wire to electrically connect the branch FFC and the main FFC.

In a further embodiment, a flat flexible cable (FFC) harness assembly is provided and includes a main FFC which includes a main FFC cable and a main connector terminated to an end of the main FFC cable. The main FFC cable includes main flat wires and a main cable body that has an insulator supporting the main flat wires. The main flat wires include terminals at the end of the main FFC terminated to the main connector. The FFC harness assembly includes a first branch FFC separate and discrete from the main FFC. The first branch FFC includes a first branch FFC cable and a first branch connector terminated to an end of the first branch FFC cable. The first branch FFC cable includes first branch flat wires and a first branch cable body having an insulator supporting the first branch flat wires. The first branch flat wires include terminals at the end of the first branch FFC terminated to the first branch connector. The FFC harness assembly includes a second branch FFC separate and discrete from the main FFC and separate and discrete from the first branch FFC. The second branch FFC includes a second branch FFC cable and a second branch connector terminated to an end of the second branch FFC cable. The second branch FFC cable includes second branch flat wires and a second branch cable body having an insulator supporting the second branch flat wires. The second branch flat wires include terminals at the end of the second branch FFC terminated to the second branch connector. The FFC harness assembly includes a first interconnect between the main FFC and the first branch FFC. The first interconnect electrically connecting at least one of the main flat wires with at least one of the first branch flat wires to electrically connect the first branch connector to the main connector. The FFC harness assembly includes a second interconnect between the main FFC and the second branch FFC. The second interconnect electrically connecting at least one of the main flat wires with at least one of the second branch flat wires to electrically connect the second branch connector to the main connector.

### BRIEF DESCRIPTION OF THE DRAWINGS

FIG. 1 illustrates a flat flexible cable (FFC) harness assembly in accordance with an exemplary embodiment.

FIG. 2 is a wiring schematic of the FFC harness assembly showing an exemplary arrangement and branching of the flat wires of the FFCs in accordance with an exemplary embodiment.

FIG. 3 is a perspective view of the interconnect in accordance with an exemplary embodiment.

FIG. 4 is a perspective view of a portion of the interconnect in accordance with an exemplary embodiment.

FIG. 5 is a perspective view of a portion of the interconnect in accordance with an exemplary embodiment showing the interconnect during assembly.

FIG. 6 is a perspective view of a portion of the interconnect in accordance with an exemplary embodiment in a partially assembled state.

FIG. 7 illustrates the FFC harness assembly in accordance with an exemplary embodiment showing the interconnects electrically connecting the branch FFCs and the main FFC.

FIG. 8 is an exploded, enlarged view of a portion of the FFC harness assembly showing the branch location between the main FFC and the branch FFC.

FIG. 9 is a schematic view of a simplified version of the FFC harness assembly in accordance with an exemplary embodiment showing the interconnects electrically connecting branch FFCs and the main FFC.

FIG. 10 is a circuit diagram of the FFC harness assembly shown in FIG. 9 in accordance with an exemplary embodiment.

### DETAILED DESCRIPTION OF THE INVENTION

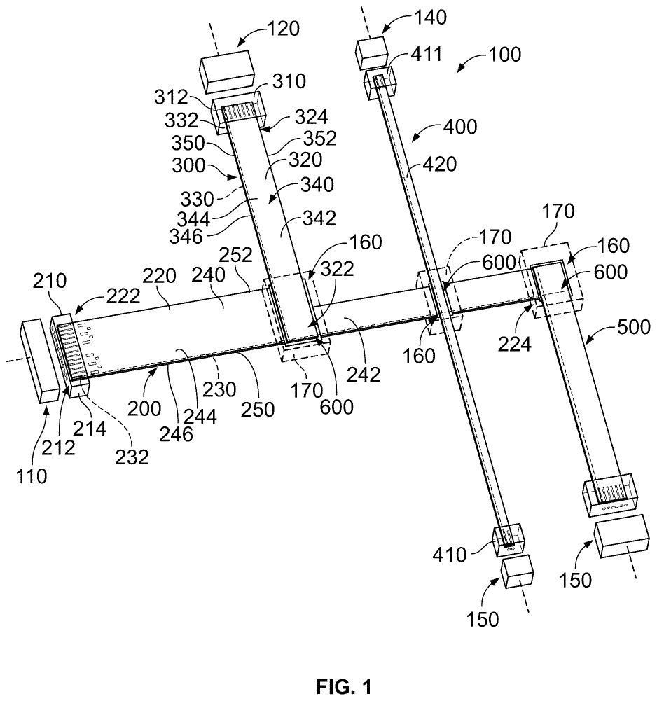

FIG. 1 illustrates a flat flexible cable (FFC) harness assembly 100 in accordance with an exemplary embodiment. The FFC harness assembly 100 is used to electrically connect components within a system. For example, the FFC harness assembly 100 may be used to electrically connect a first component 110 with one or more additional components, such as a second component 120, a third component 130, a fourth component 140, and a fifth component 150. The FFC harness assembly 100 may be used to connect greater or fewer components in alternative embodiments. The FFC harness assembly 100 may transmit electrical power and signals between the various components 110-150, such as the control module, the battery, lighting devices, sensors, and the like.

In an exemplary embodiment, the FFC harness assembly 100 is used in an automotive application, such as to connect a vehicle control or management system to electronic controls, lighting, air conditioning, and other components of the vehicle. For example, the first component 110 may be a vehicle control module and the other components 120-150 may be lighting assemblies within the vehicle. The components 110-150 may be other devices or assemblies within the vehicle in alternative embodiments. In an exemplary embodiment, the FFC harness assembly 100 is a roof or headliner harness assembly configured to be arranged in the headliner of the vehicle. The FFC harness assembly 100 may be used in other applications in alternative embodiments, such as aerospace, defense, appliances, automation, industrial machines, and the like.

The FFC harness assembly 100 includes a main FFC 200 and a plurality of branch FFCs 300, 400, 500 interconnected with the main FFC 200 by one or more interconnects 600. Greater or fewer branch FFCs may be used in alternative embodiments depending on the wiring pattern and number and layout of the components 110-150. In other various embodiments, the interconnect(s) 600 may be used to connect the FFC to a rigid component, such as a printed circuit board (PCB). For example, the main component may be a PCB and the FFCs 300, 400. 500 may be connected to the main PCB by the interconnects 600. In other embodiments, one or more of the secondary components 300, 400, 500 may be a PCB connected to th main FFC 200. The branch FFCs 300, 400, 500 are electrically connected to the main FFC 200 at branch locations 160 by the interconnect(s) 600. The interconnect 600 forms an electrical take-off configured to electrically connect the branch FFC 300, 400, 500 to the main FFC 200. The branch locations 160 may be located at an end of the main FFC 200 and/or at an intermediate location along the length of the main FFC 200. The branch FFCs 300, 400, 500 extend outward from the main FFC 200, such as at an angle nonparallel to the main FFC 200. In other various embodiments, the branch FFCs 300, 400. 500 may extend parallel to the main FFC 200, such as above or below the main FFC 200, such as to have a duplicate branch (for example, Y-branch). In the illustrated embodiment, the branch FFC's 300, 400, 500 extend perpendicular to the main FFC 200. However, the branch FFCs 300, 400, 500 may extend at other angles transverse to the main FFC 200, such as acute angles or obtuse angles. In other various embodiments, one or more of the branch FFCs 300, 400, 500 may be electrically connected to another one of the branch FFCs 300, 400, 500 rather than the main FFC 200 by the corresponding interconnect(s) 600.

In an exemplary embodiment, the FFC harness assembly 100 is a generally planar harness assembly, such as for assembly into the headliner or roof of the vehicle. However, because the FFCs are flexible, one or more of the FFC's may be nonplanar, such as to extend along curved paths. In various embodiments, the main FFC 200 may extend generally horizontally while portions of one or more of the branch FFCs 300, 400, 500 may extend generally vertically to route to the corresponding components within the vehicle.

The main FFC 200 includes a main FFC cable 220 extending between a first end 222 and a second end 224. The main FFC 200 includes a main connector 210 terminated to the first end 222 of the main FFC cable 220. The main FFC cable 220 includes main flat wires 230 and a main cable body 240. The main flat wires 230 may be signal wires, ground wires and/or power wires. The main flat wires 230 are arranged at a predetermined edge or spacing therebetween. The main flat wires 230 extend parallel to each other along the length of the main cable body 240.

The main flat wires 230 include terminals 232 at the first end 222 configured to be terminated to the main connector 210. For example, the main connector 210 may include contacts 212 held by a housing 214 that are terminated to the terminals 232. The contacts 212 may be soldered to the terminals 232. The terminals 232 are defined by exposed portions of the main flat wires 230, such as by removing portions of the main cable body 240 to form windows exposing the terminals 232. The terminals 232 may be located at or proximate to the first end 222. In various embodiments, the main flat wires 230 are made from rolled wire stock, such as rectangular wire stock. In other various embodiments, the main flat wires 230 may be stamped wires 230 or etched from a sheet similar to a FPC (flexible printed circuit) process. The main flat wires 230 extends along parallel paths, such as between the ends 222, 224 of the main FFC cable 220. The main flat wires 230 include planar or flat upper and lower surfaces. In an exemplary embodiment, the main flat wires 230 are manufactured from a metal material, such as copper or copper alloy. The main flat wires 230 may be aluminum or aluminum alloys. The main flat wires 230 may be plated or coated. In an exemplary embodiment, at least some of the main flat wires 230 may be terminated to the branch FFC's at the branch locations 160. At least some of the main flat wires 230 may extend an entire length of the main FFC cable 220 (for example, from the first end 222 to the second end 224). At least some of the main flat wires 230 may extend only a partial length of the main FFC cable 220, such as stopping at the branch location(s) 160.

The main cable body 240 includes an insulator 242 supporting the main flat wires 230. In an exemplary embodiment, the insulator 242 is thin and flexible. The insulator 242 may be manufactured from a dielectric material, such as polyethylene terephthalate (PET) or polyethylene naphthalate (PEN). The insulator 242 surrounds the main flat wires 230 and holds relative positions of the main flat wires 230. In an exemplary embodiment, the insulator 242 includes one or more insulating sheets. For example, the insulator 242 may include two insulating sheets that are laminated together with the array of main flat wires 230 therebetween. In an exemplary embodiment, each insulating sheet includes a base sheet and an adhesive layer. In other various embodiments, the insulator 242 may be extruded over the main flat wires 230. The insulator 242 includes an upper surface 244 and a lower surface 246. The insulator 242 extends between a first edge 250 and a second edge 252. In an exemplary embodiment, the insulator 242 may be stepped inward such that the insulator has different widths between the first and second edges 250, 252 along the length of the main cable body 240. For example, downstream of one or more of the branch locations 160, the width may be stepped inward, such as due to the main flat wires 230 being terminated at the branch locations and unnecessary to extend the entire length of the main FFC cable 220.

The branch FFCs 300, 400, 500 may be similar to each other and are described in detail relative to the branch FFC 300. However, the other branch FFCs 400, 500 may have like components identified with like reference numerals. The branch FFCs 300, 400, 500 are separate and discrete from the main FFC 200. For example, the branch FFCs 300, 400, 500 are separately manufactured as different FFCs, such as having different flat wires and cable bodies. The branch FFCs 300, 400, 500 are separately manufactured from each other, such as from different FFCs.

The branch FFC 300 includes a branch FFC cable 320 extending between a first end 322 and a second end 324. The first end 322 of the branch FFC cable 320 may be electrically connected to the corresponding interconnect 600. Alternatively, the branch FFC cable 320 may be electrically connected to the corresponding interconnect at an intermediate location remote from both the first and second ends 322, 324. The branch FFC 300 includes a branch connector 310 terminated to the second end 324 of the branch FFC cable 320. In the illustrated embodiment, the branch FFC 400 includes a pair of branch connectors 410, 411 at opposite ends of the branch FFC cable 420, wherein the branch FFC cable 420 is terminated to the main FFC cable 220 at an intermediate location rather than at one of the ends of the branch FFC cable 420.

The branch FFC cable 320 includes branch flat wires 330 and a branch cable body 340. The branch flat wires 330 may be signal wires, ground wires and/or power wires. The branch flat wires 330 are arranged at a predetermined pitch or spacing between wires. The pitch between the branch flat wires 330 may be the same as the pitch between the main flat wires 230. The branch flat wires 330 may extend parallel to each other.

The branch flat wires 330 include terminals 332 at the second end 324 configured to be terminated to the branch connector 310. For example, the branch connector 310 may include contacts 312 held by a housing 314 that are terminated to the terminals 332. The contacts 312 may be soldered to the terminals 332. In various embodiments, the branch flat wires 330 are made from rolled wire stock, such as rectangular wire stock. In other various embodiments, the branch flat wires 330 may be stamped, slit sheet metal or etched sheet. The branch flat wires 330 may have the same dimensions (for example, width and thickness) as the main flat wires 230 in various embodiments. Alternatively, the branch flat wires 330 may have different dimensions (for example, width and/or thickness) as the main flat wires 230. The branch flat wires 330 extends along parallel paths, such as between the ends 322, 324 of the branch FFC cable 320. The branch flat wires 330 include planar or flat upper and lower surfaces. In an exemplary embodiment, the branch flat wires 330 are manufactured from a metal material, such as copper or copper alloy. The branch flat wires 330 may be aluminum or aluminum alloys. The branch flat wires 330 may be plated or coated. The branch flat wires 330 may be manufactured from the same material as the main flat wires 230 in various embodiments. Alternatively, the branch flat wires 330 may be manufactured from a different material as the main flat wires 230.

In an exemplary embodiment, all of the branch flat wires 330 are electrically connected to the main FFC 200 at the corresponding branch location 160. In alternative embodiments, only some, but not all, of the branch flat wires 330 are electrically connected to the main FFC 200 at the corresponding branch location 160. At least some of the branch flat wires 330 may extend an entire length of the branch FFC cable 320 (for example, from the first end 322 to the second end 324). At least some of the branch flat wires 330 may extend only a partial length of the branch FFC cable 320, such as stopping at a branch location 160.

The branch cable body 340 includes an insulator 342 supporting the branch flat wires 330. In an exemplary embodiment, the insulator 342 is thin and flexible. The insulator 342 may be manufactured from a dielectric material, such as polyethylene terephthalate (PET) or polyethylene naphthalate (PEN). The insulator 342 surrounds the branch flat wires 330 and holds relative positions of the branch flat wires 330. In an exemplary embodiment, the insulator 342 includes one or more insulating sheets. For example, the insulator 342 may include two insulating sheets that are laminated together with the array of branch flat wires 330 therebetween. In an exemplary embodiment, each insulating sheet includes a base sheet and an adhesive layer. In other various embodiments, the insulator 342 may be overmolded/extruded over the branch flat wires 330. The insulator 342 includes an upper surface 344 and a lower surface 346. The insulator 342 extends between a first edge 350 and a second edge 352. In an exemplary embodiment, the insulator 342 may be stepped inward such that the insulator has different widths between the first and second edges 350, 352 along the length of the branch cable body 340.

In an exemplary embodiment, the interconnects 600 are positioned at the branch locations 160 between the main FFC 200 and the branch FFC 300 (and/or the branch FFCs 400, 500) to electrically connect the main FFC 200 and the branch FFC 300. For example, the interconnects 600 electrically connect the main flat wires 230 with the branch flat wires 330 to electrically connect the branch connector 310 to the main connector 210. In an exemplary embodiment, the interconnect 600 is stacked with the main FFC 200 and the branch FFC 300, such as with the main FFC 200 at the bottom (or the top) and the branch FFC 300 at the top (or the bottom) and with the interconnect 600 between the main FFC 200 and the branch FFC 300. The interconnect 600 may be coupled to another structure, such as a mounting structure, a chassis, frame, piece of sheet metal, bracket or other mounting structure. For example, the interconnect 600 may include a fastener, clip, latch or other element to mount the interconnect 600 to the mounting structure. The interconnect 600 may include a flange or bracket extending therefrom for mounting to the mounting structure. In various embodiments, the interconnect 600 may include one or more openings, such as to receive a fastener, clip, or other mounting hardware. Such mounting may reduce stress or strain on the other components, such as the main FFC 200 and/or the branch FFCs 300, 400, 500.

In an exemplary embodiment, the FFC harness assembly 100 includes an outer housing 170 at the branch location 160 surrounding the stack of the main FFC 200, the branch FFC 300, and the interconnect 600. The outer housing 170 surrounds the components at the branch location 160, such as to protect the components. The outer housing 170 may provide strain relief for the connections. The outer housing 170 may provide a sealed interface around the connections. In an exemplary embodiment, the outer housing 170 may be used for mounting the FFC harness assembly 100 in the vehicle. For example, the outer housing 170 may include a mounting features, such as a mounting flange or mounting bracket, for mounting to the vehicle and thus position the FFC harness assembly 100 in the vehicle. The outer housing 170 may be coupled to another structure, such as a mounting structure, a chassis, frame, piece of sheet metal, bracket or other mounting structure. For example, the outer housing 170 may include a fastener, clip, latch or other element to mount the outer housing 170 to the mounting structure. Such mounting may reduce stress or strain on the other components, such as the interconnect 600, the main FFC 200 and/or the branch FFCs 300, 400, 500. The outer housing 170 may be a multi-piece housing, such as including an upper shell and a lower shell configured to be coupled together to surround the main FFC 200, the branch FFC 300, and the interconnect 600 at the branch location 160.

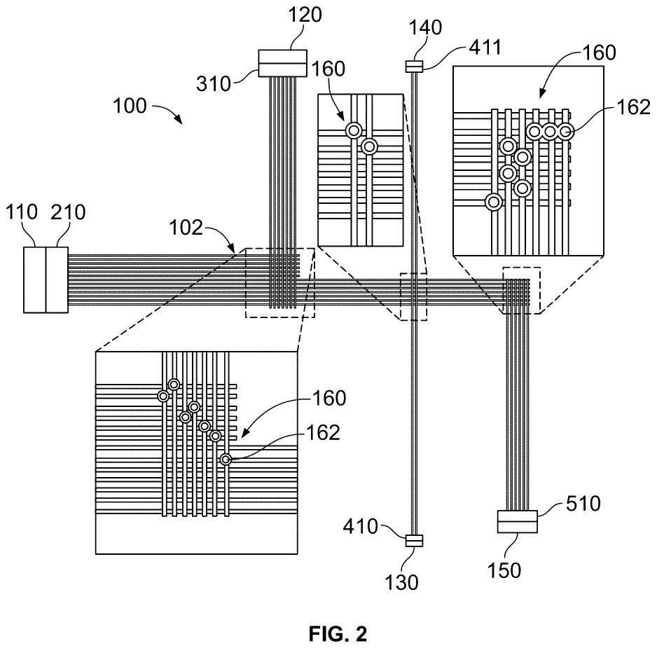

FIG. 2 is a wiring schematic of the FFC harness assembly 100 showing an exemplary arrangement and branching of the flat wires of the FFCs in accordance with an exemplary embodiment. The flat wires of the FFCs of the FFC harness assembly 100 form channels or lines 102 between the components 110-150. The lines 102 may be data lines and/or power lines and/or ground lines. The lines 102 are connected to the corresponding FFC connectors of the FFCs. The lines 102 of the various FFCs are electrically connected at connections 162 at the branch locations 160. Optionally, the lines 102 of one FFC may be connected to one or more lines 102 of another FFC depending on the particular wiring pattern.

In an exemplary embodiment, the main connector 210 is configured to be coupled to the main component 110. The branch connectors 310, 410, 411, 510 are configured to be coupled to the corresponding secondary components 120, 130, 140, 150. The lines 102 are routed between the main connector 210 and the branch connectors 310, 410, 411, 510. The interconnects 600 (shown in FIG. 1) allow data and/or power take off between the FFCs. Optionally, one or more of the lines 102 may have one or more take-offs at the branch locations 160.

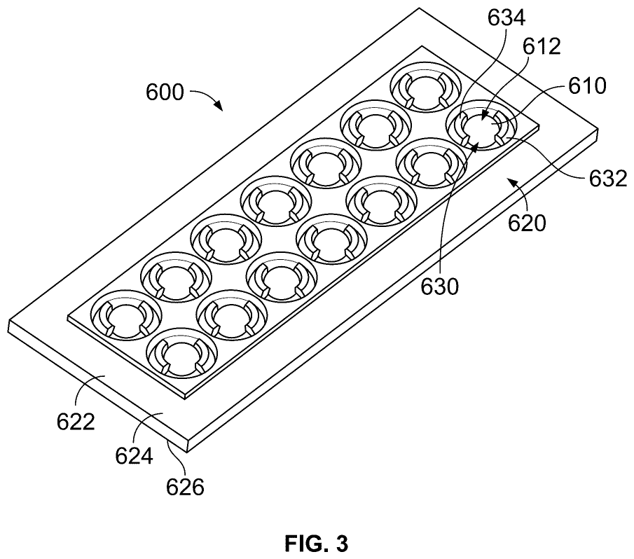

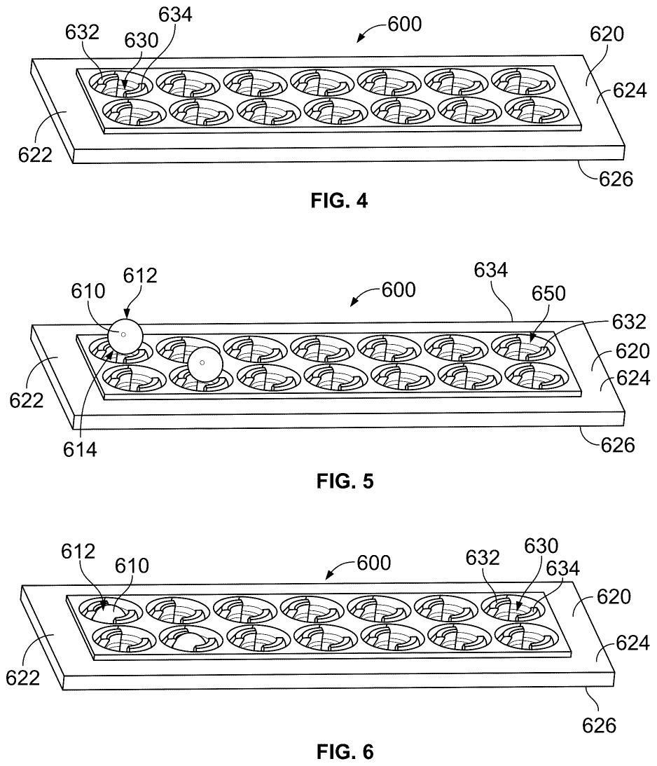

FIG. 3 is a perspective view of the interconnect 600 in accordance with an exemplary embodiment. FIG. 4 is a perspective view of a portion of the interconnect 600 in accordance with an exemplary embodiment. FIG. 5 is a perspective view of a portion of the interconnect 600 in accordance with an exemplary embodiment showing the interconnect 600 during assembly. FIG. 6 is a perspective view of a portion of the interconnect 600 in accordance with an exemplary embodiment in a partially assembled state. The interconnect 600 includes an interconnect housing 620 and interconnect conductors 610 held by the interconnect housing 620.

The interconnect conductors 610 are configured to electrically connect the main flat wire 230 with the corresponding branch flat wire 330 (shown in FIG. 1). For example, the interconnect conductors 610 may be soldered to the corresponding main flat wires 230 in the branch flat wires 330. In an exemplary embodiment, each interconnect conductor 610 includes a first interface 612 configured to be electrically connected to the corresponding main flat wire 230 and a second interface 614 configured to be electrically connected to the corresponding branch flat wire 330 to electrically connect the branch FFC 300 and the main FFC 200. In an exemplary embodiment, the interconnect conductor 610 is manufactured from a metal material, such as copper or copper alloy. The interconnect conductor 610 may be manufactured from other materials, such as aluminum or aluminum alloys, stainless steel, or other metal materials. The interconnect conductor 610 may include one or more coating or plating layers. In an exemplary embodiment, the interconnect conductor 610 may include solder, such as solder paste, at the first interface 612 and/or the second interface 614.

In the illustrated embodiment, the interconnect conductors 610 are spherical shaped. For example, the interconnect conductors 610 may be spherical balls. However, the interconnect conductors 610 may have other shapes in alternative embodiments, such as being rectangular. For example, the interconnect conductors 610 may include pads or plates. The interconnect conductors 610 may be conductive columns, such as plated vias or solder filled vias through the interconnect housing 620. The interconnect conductors 610 may be hourglass-shaped. In other various embodiments, the interconnect conductors 610 may be stamped and formed. The interconnect conductors 610 may be contacts having one or more spring beams. The interconnect conductors may be conductive elastomer contacts in various embodiments. In other various embodiments, the interconnect conductors 610 may be plated circuits, such as circuits of a plated circuit board.

In an exemplary embodiment, the interconnect housing 620 includes a panel 622 holding the interconnect conductors 610. The panel 622 includes an upper surface 624 and a lower surface 626. The panels 622 has a thickness between the upper surface 624 and the lower surface 626. The thickness may be narrower than the height of the interconnect conductors 610 such that the interconnect conductors 610 are exposed at and/or stand proud of the upper surface 624 and/or the lower surface 626. The upper surface 624 may face the main FFC cable 220 and a lower surface 626 may face the branch FFC cable 320. The interconnect conductors 610 extend between the upper surface 624 and the lower surface 626 to interface with the corresponding main flat wire 230 and the branch flat wire 330. In various embodiments, the panel 622 may be a substrate of a printed circuit board and the interconnect conductors 610 may be circuits of the printed circuit board formed on one or more layers of the printed circuit board.

The interconnect housing 620 includes openings 630 therethrough, such as between the upper and lower surfaces 624, 626. The openings 630 receive the interconnect conductors 610. Optionally, all of the openings 630 may receive the corresponding interconnect conductors 610. In alternative embodiments, select openings 630 may receive the corresponding interconnect conductors 610 while other openings are empty and do not receive any interconnect conductors 610. The locations of the interconnect conductors 610 may be selected to correspond to the pin out or wiring arrangement for the FFC harness assembly 100. The openings 630 are arranged in an array, such as in multiple rows and multiple columns. While the openings 630 are shown including two rows and seven columns, the interconnect housing 620 may include greater or fewer rows and greater or fewer columns of the openings 630 in alternative embodiments. The pitch or spacing between the openings 630 may be selected to correspond to the pitch between the main flat wires 230 and/or the branch flat wires 330. In an exemplary embodiment, the interconnect housing 620 includes securing features 632 at the openings 630. The securing features 632 secure the interconnect conductors 610 in the openings 630. The securing features 632 may include clips or latches 634 configured to engage the interconnect conductors 610 and secure the interconnect conductors 610 in the openings 630. The latches 634 may include deflectable latch arms. Other types of securing features may be used in alternative embodiments.

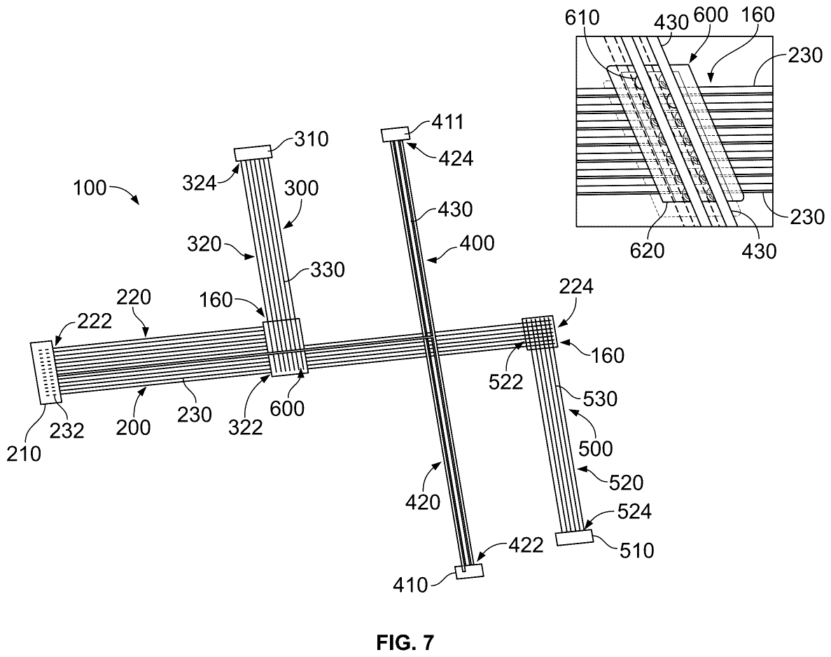

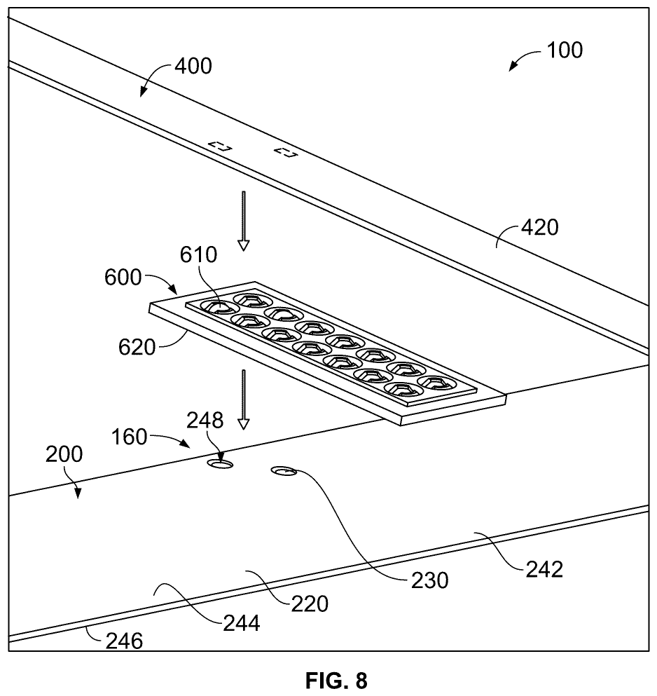

FIG. 7 illustrates the FFC harness assembly 100 in accordance with an exemplary embodiment showing the interconnects 600 electrically connecting the branch FFCs 300, 400, 500 and the main FFC 200. FIG. 8 is an exploded, enlarged view of a portion of the FFC harness assembly 100 showing the branch location between the main FFC 200 and the branch FFC 400.

The branch FFCs 300, 400, 500 are electrically connected to the main FFC 200 at the branch locations 160 by the interconnect(s) 600. The interconnects 600 form the electrical take-offs or branches from the main FFC 200 to route the electrical lines to the different components by the branch FFC 300, 400, 500. In the illustrated embodiment, the branch FFC 500 is located at the end 224 of the main FFC 200, whereas the branch FFCs 300, 400 are located at intermediate locations along the main FFC 200 remote from the ends 222, 224. However, in an alternative embodiment, the end 224 of the main FFC 200 may extend beyond the branch FFC 500 and include a second main connector (not shown) at the end 224. In other alternative embodiments, other branch FFCs may extend from one or more of the illustrated branch FFCs 300, 400, 500.

The main FFC 200 includes the main connector 210 at the end 222 of the main FFC cable 220 connected to the terminals 232 of the main flat wires 230. At least some of the main flat wires 230 may extend an entire length of the main FFC cable 220 (for example, from the first end 222 to the second end 224). At least some of the main flat wires 230 may extend only a partial length of the main FFC cable 220, such as stopping at the branch location(s) 160. The main flat wires 230 extend from the main connector 210 and are electrically connected to the branch FFCs 300, 400, 500 by the interconnects 600. In various embodiments, at least one of the main flat wires 230 is electrically connected to at least two of the branch flat wires of the branch FFCs 300, 400, 500.

In an exemplary embodiment, at least some of the main flat wires 230 are exposed at the branch locations 160. For example, one or more windows 248 (FIG. 8) are formed in the insulator 242, such as at the upper surface 244 and the lower surface 246. The windows 248 are aligned with the main flat wires 230 to expose the main flat wires 230. The interconnect conductors 610 are configured to be terminated (for example, soldered) to the main flat wires 230 through the windows 248. The interconnect conductors 610 may pass through the windows 248 to interface with the main flat wires 230. The interconnect conductors 610 may be soldered to the main flat wires 230 in the windows 248. The windows 248 may be staggered, such as in rows and/or columns to expose the various main flat wires 230 at the branch locations 160. Optionally, one or more of the windows 248 may be aligned along the same main flat wire 230 to branch or take-off from the same main flat wire 230 to more than one branch flat wire.

The branch FFCs 300, 400, 500 have a similar structure to the main FFC 200. For example, the branch FFCs 300, 400, 500 include windows, similar to the windows 248, that expose the branch flat wires for electrical connection to the interconnect conductors 610. In various embodiments, at least one of the branch flat wires 330, 430, 530 is electrically connected to at least two of the main flat wires 230.

The interconnects 600 are positioned at the branch locations 160 between the main FFC 200 and the branch FFC 300 (and/or the branch FFCs 400, 500) to electrically connect the main FFC 200 and the branch FFCs 300, 400, 500. For example, the interconnects 600 electrically connect the main flat wires 230 with the branch flat wires. In an exemplary embodiment, the interconnect 600 is stacked between the main FFC 200 and the branch FFCs 300, 400, 500. The interconnect housing 620 holds the interconnect conductors 610 at predetermined locations, such as at a predetermined pitch or spacing, to align with the windows 248 for electrical connection to the main flat wires 230 and the branch flat wires. The interconnect conductors 610 may be held in one or more rows and one or more columns of the interconnect housing 620 depending on the particular branch layout.

In the illustrated embodiment, the first end 322 of the branch FFC cable 320 is located at the branch location 160 for electrical connection to the main FFC 200 by the corresponding interconnect 600. The branch location 160 is at an intermediate location along the main FFC cable 220, such as closest to the first end 222 of the main FFC cable 220. In the illustrated embodiment, seven of the branch flat wires 330 are electrically connected to the corresponding main flat wires 230 by the interconnect 600. The branch flat wires 330 are electrically connected to the branch connector 310 at the second end 324 of the branch FFC cable 320.

In the illustrated embodiment, the branch FFC 400 includes the pair of the branch connectors 410, 411 at the opposite ends 422, 424 of the branch FFC cable 420. The branch location 160 is located at an intermediate location along the branch FFC cable 420, such as approximately centered between the ends 422, 424, for electrical connection to the main FFC 200 by the corresponding interconnect 600. The branch location 160 is at an intermediate location along the main FFC cable 220, such as between the branch locations 160 for the other branch FFCs 300, 500. In the illustrated embodiment, two of the branch flat wires 430 are electrically connected to the corresponding main flat wires 230 by the interconnect 600. For example, the interconnect 600 is positioned between the branch FFC 400 and the main FFC 200 and the interconnect conductors 610 are aligned with the windows 248 in the main FFC cable 220 and the windows in the branch FFC cable 420 to solder to the corresponding main flat wires 230 and the branch flat wires 430.

In the illustrated embodiment, the first end 522 of the branch FFC cable 520 is located at the branch location 160 for electrical connection to the main FFC 200 by the corresponding interconnect 600. The branch location 160 is at the second end 224 of the main FFC cable 220. Other locations are possible in alternative embodiments. In the illustrated embodiment, six of the branch flat wires 530 are electrically connected to the corresponding main flat wires 230 by the interconnect 600. The branch flat wires 530 are electrically connected to the branch connector 510 at the second end 524 of the branch FFC cable 520.

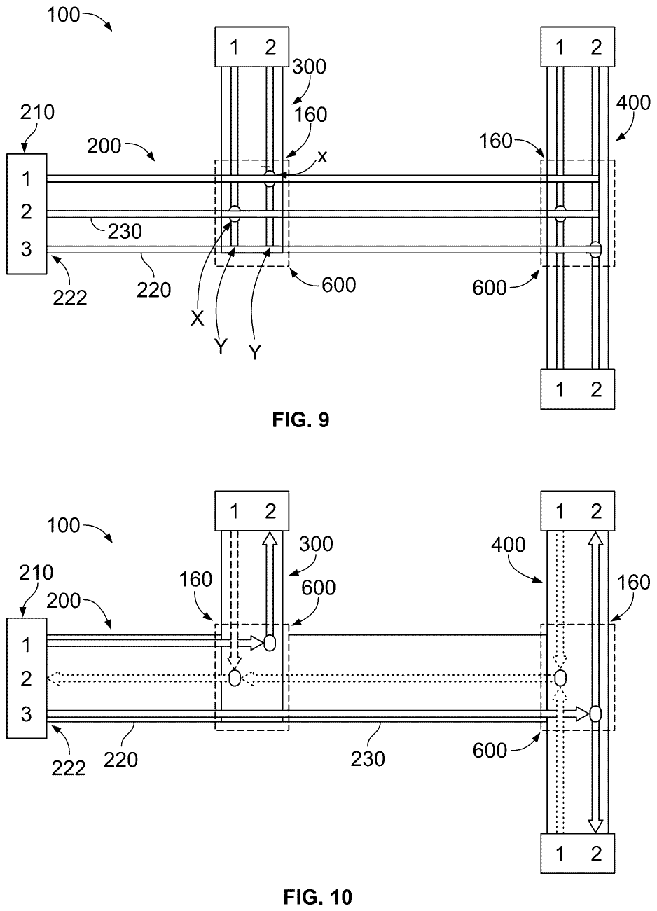

FIG. 9 is a schematic view of a simplified version of the FFC harness assembly 100 in accordance with an exemplary embodiment showing the interconnects 600 electrically connecting branch FFCs 300, 400 and the main FFC 200. FIG. 10 is a circuit diagram of the FFC harness assembly 100 shown in FIG. 9 in accordance with an exemplary embodiment.

The branch FFCs 300, 400 are electrically connected to the main FFC 200 at the branch locations 160 by the interconnect(s) 600. The interconnects 600 form the electrical take-offs or branches from the main FFC 200 to route the electrical lines to the different components by the branch FFC 300, 400. In an exemplary embodiment, the interconnects 600 may be selectively populated with the interconnect conductors 610 to allow a selective electrical connection between the various conductors of the main FFC cable 220 and the branch FFCs 300,400. For example, locations X allow a connection between conductors in the main FFC 200 and the branch FFCs 300, 400, while locations Y do not.

The main FFC 200 includes the main connector 210 at the end 222 of the main FFC cable 220 connected to the terminals 232 of the main flat wires 230. The main flat wires 230 extend from the main connector 210 and are electrically connected to the branch FFCs 300, 400 by the interconnects 600. The interconnects 600 are positioned at the branch locations 160 between the main FFC 200 and the branch FFCs 300, 400 to electrically connect the main FFC 200 and the branch FFCs 300, 400. For example, the interconnects 600 electrically connect the main flat wires 230 with the branch flat wires 330, 430. Circuits are formed between the main flat wires 230 and the branch flat wires 330, 430 through the interconnects 600 allowing branching of the various transmission lines through the various FFCs.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A flat flexible cable (FFC) harness assembly comprising:
a main FFC including a main FFC cable and a main connector terminated to an end of the main FFC cable, the main FFC cable including main flat wires and a main cable body having an insulator supporting the main flat wires, the main flat wires including terminals at the end of the main FFC terminated to the main connector;
a branch FFC separate and discrete from the main FFC, the branch FFC including a branch FFC cable and a branch connector terminated to an end of the branch FFC cable, the branch FFC cable including branch flat wires and a branch cable body having an insulator supporting the branch flat wires, the branch flat wires including terminals at the end of the branch FFC terminated to the branch connector; and
an interconnect at a branch location between the main FFC and the branch FFC, the interconnect located between the main FFC and the branch FFC, the interconnect electrically connecting at least one of the main flat wires with at least one of the branch flat wires to electrically connect the branch connector to the main connector.

2. The FFC harness assembly of claim 1, wherein the main FFC and the branch FFC are stacked with the interconnect therebetween.

3. The FFC harness assembly of claim 1, wherein the branch FFC cable extends nonparallel to the main FFC cable.

4. The FFC harness assembly of claim 1, wherein the interconnect includes an interconnect housing and interconnect conductors held by the interconnect housing, each interconnect conductor including a first interface electrically connected to the corresponding main flat wire and a second interface electrically connected to the corresponding branch flat wire to electrically connect the branch FFC and the main FFC.

5. The FFC harness assembly of claim 4, wherein the interconnect housing includes a panel having an upper surface facing the main FFC cable and a lower surface facing the branch FFC cable, the interconnect conductors extending between the upper surface and the lower surface to interface with the corresponding main flat wire and the branch flat wire.

6. The FFC harness assembly of claim 4, wherein the interconnect housing includes openings receiving the interconnect conductors.

7. The FFC harness assembly of claim 4, wherein the interconnect conductors are spherical shaped.

8. The FFC harness assembly of claim 4, wherein the interconnect is a printed circuit board, the interconnect housing including a substrate, the interconnect conductors include circuits of the printed circuit board formed on one or more layers of the substrate.

9. The FFC harness assembly of claim 4, wherein the interconnect conductors are soldered to the corresponding main flat wire and branch flat wire.

10. The FFC harness assembly of claim 1, further comprising an outer housing at the branch location surrounding the stack of the main FFC, the branch FFC and the interconnect.

11. The FFC harness assembly of claim 1, wherein the branch FFC is coupled to the main FFC at a second end of the main FFC cable opposite the end having the main connector.

12. The FFC harness assembly of claim 1, wherein the branch FFC is coupled to the main FFC at an intermediate location between the end of the main FFC cable and a second end of the main FFC cable.

13. The FFC harness assembly of claim 1, wherein the main cable body includes windows exposing the main flat wires, the branch cable body including windows exposing the branch flat wires, the interconnect connected to the corresponding main flat wires and branch flat wires through the windows.

14. The FFC harness assembly of claim 1, wherein at least one of the main flat wires is electrically connected to at least two of the branch flat wires.

15. The FFC harness assembly of claim 1, wherein at least one of the branch flat wires is electrically connected to at least two of the main flat wires.

16. The FFC harness assembly of claim 1, wherein the branch FFC includes a second branch connector terminated to a second end of the branch FFC cable.

17. The FFC harness assembly of claim 1, further comprising a second branch FFC separate and discrete from the branch FFC, the second branch FFC including a second branch FFC cable and a second branch connector terminated to an end of the second branch FFC cable, the second branch FFC cable including second branch flat wires and a second branch cable body, the interconnect electric the connecting at least one of the main flat wires with at least one of the second branch flat wires to electrically connect the second branch connector to the main connector.

18. The FFC harness assembly of claim 1, further comprising:
a second branch FFC separate and discrete from the branch FFC, the second branch FFC including a second branch FFC cable and a second branch connector terminated to an end of the second branch FFC cable, the second branch FFC cable including second branch flat wires and a second branch cable body; and
a second interconnect between the main FFC and the second branch FFC, the second interconnect electrically connecting at least one of the main flat wires with at least one of the second branch flat wires to electrically connect the second branch connector to the main connector.

19. A flat flexible cable (FFC) harness assembly comprising:
a main FFC including a main FFC cable and a main connector terminated to an end of the main FFC cable, the main FFC cable including main flat wires and a main cable body having an insulator supporting the main flat wires, the main flat wires including terminals at the end of the main FFC terminated to the main connector;
a branch FFC separate and discrete from the main FFC, the branch FFC including a branch FFC cable and a branch connector terminated to an end of the branch FFC cable, the branch FFC cable including branch flat wires and a branch cable body having an insulator supporting the branch flat wires, the branch flat wires including terminals at the end of the branch FFC terminated to the branch connector; and
an interconnect between the main FFC and the branch FFC, the interconnect including an interconnect housing and interconnect conductors held by the interconnect housing, each interconnect conductor including a first interface electrically connected to the corresponding main flat wire and a second interface electrically connected to the corresponding branch flat wire to electrically connect the branch FFC and the main FFC.

20. A flat flexible cable (FFC) harness assembly comprising:
a main FFC including a main FFC cable and a main connector terminated to an end of the main FFC cable, the main FFC cable including main flat wires and a main cable body having an insulator supporting the main flat wires, the main flat wires including terminals at the end of the main FFC terminated to the main connector;
a first branch FFC separate and discrete from the main FFC, the first branch FFC including a first branch FFC cable and a first branch connector terminated to an end of the first branch FFC cable, the first branch FFC cable including first branch flat wires and a first branch cable body having an insulator supporting the first branch flat wires, the first branch flat wires including terminals at the end of the first branch FFC terminated to the first branch connector;
a second branch FFC separate and discrete from the main FFC and separate and discrete from the first branch FFC, the second branch FFC including a second branch FFC cable and a second branch connector terminated to an end of the second branch FFC cable, the second branch FFC cable including second branch flat wires and a second branch cable body having an insulator supporting the second branch flat wires, the second branch flat wires including terminals at the end of the second branch FFC terminated to the second branch connector;
a first interconnect between the main FFC and the first branch FFC, the first interconnect electrically connecting at least one of the main flat wires with at least one of the first branch flat wires to electrically connect the first branch connector to the main connector; and
a second interconnect between the main FFC and the second branch FFC, the second interconnect electrically connecting at least one of the main flat wires with at least one of the second branch flat wires to electrically connect the second branch connector to the main connector.
